(19) United States
(12) Patent Application Publication
(10) Pub. No.: US 2026/0236270 A1
(43) Pub. Date: Aug. 13, 2026

(54) CONTAINER STARTING METHOD, AND DEVICE, STORAGE MEDIUM AND SYSTEM

(71) Applicant: CLOUD INTELLIGENCE ASSETS HOLDING (SINGAPORE) PRIVATE LIMITED, Singapore (SG)

(72) Inventors: Xianbin TANG, Hangzhou, Zhejiang (CN); Jie CHEN, Shenzhen, Guangdong (CN); Tianlong WU, Hangzhou, Zhejiang (CN); Zhe FAN, Shenzhen, Guangdong (CN); Eryu GUAN, Beijing (CN); Manyou YANG, Shenzhen, Guangdong (CN)

(73) Assignee: CLOUD INTELLIGENCE ASSETS HOLDING (SINGAPORE) PRIVATE LIMITED, Singapore (SG)

(21) Appl. No.: 19/471,710

(22) PCT Filed: Apr. 2, 2024
(86) PCT No.: PCT/CN2024/085602

§ 371 Date: Oct. 2, 2025

(30) Foreign Application Priority Data
Apr. 4, 2023 (CN) 202310397269.7

(51) Int. Cl. G06F 9/445

(52) U.S. Cl. CPC G06F 9/44505

(57) ABSTRACT

A container startup method includes: acquiring running environment configuration information of an application code file; according to the running environment configuration information, creating, in a server, a target container for running the application code file; acquiring a metadata file from a target storage space in which a metadata file corresponding to the application code file and a compressed data file are stored, so as to transmit the metadata file to the target container, wherein catalogue index information of each data block in the data file is stored in the metadata file; and in response to a starting data reading request, reading starting data from the target storage space according to requirements, and transmitting starting data, which is decompressed according to requirements, to the target container, such that the target container runs the starting data to complete the starting of the target container.

### CROSS REFERENCE TO RELATED APPLICATIONS

This disclosure is a National Stage of International Stage of International Application PCT/CN2024/085602 filed on Apr. 2, 2024, which claims priority to Chinese Patent Application No. CN202310397269.7, filed on Apr. 4, 2023 and entitled “CONTAINER STARTING METHOD, AND DEVICE, STORAGE MEDIUM AND SYSTEM”, the entire contents of the mentioned applications are incorporated herein by reference in their entireties.

### TECHNICAL FIELD

The present disclosure relates to the field of cloud computing technologies, and in particular, to a container startup method and device, a storage medium, and a system.

### BACKGROUND

A serverless architecture is a new serverless application development architecture, which allows users to avoid purchasing, maintaining, setting up a server environment, installing software, and the like, which are completed by cloud vendors. To be specific, the users do not need to pay attention to servers, but only focus on development of application code and pay based on cloud resources actually used, thereby simplifying the development of application code.

Function computing service is a form of the serverless architecture, which provides fully managed event-driven computing services. Through function computing service, a user does not need to purchase or manage infrastructure such as a server, and only needs to write and upload application code. The function computing service is to prepare relevant computing resources for the user, run application code of the user in an elastic and reliable manner, and may provide functions such as log query, alarm, and performance monitoring.

To run the application code of the user, a container for running the application code first needs to be constructed. A conventional manner of deploying application code is as follows. The application code of the user is uploaded in a compressed form such as ZIP to a storage space in the cloud. The function computing service downloads the compressed code package to perform a cold start on the container and execute the application code of the user. The cold start refers to a process in which the function computing service needs to create, for the application code, an execution environment (that is, a container) where the application code may be run. During deployment using an original ZIP code package on the function computing service, steps such as full downloading of the compressed code package and full decompression of the compressed code package need to be performed during the cold start. A larger compressed code package to be downloaded indicates a longer time consumed for decompression, resulting in a slower cold start speed, that is, it takes a longer time to start a container.

### SUMMARY

Embodiments of the present disclosure provide a container startup method and device, a storage medium, and a system, to reduce time for creating a container that runs application code.

According to a first aspect, an embodiment of the present disclosure provides a container startup method, applied to a server. The method includes:
obtaining runtime environment configuration information of an application code file;
creating, in the server, a target container for running the application code file based on the runtime environment configuration information;
obtaining, from a target storage space storing a metadata file and a compressed data file both of which correspond to the application code file, the metadata file, to transfer the metadata file to the target container, where the metadata file stores directory index information of each data block in the data file; and
reading, in response to a startup data read request triggered by the target container based on the directory index information, corresponding startup data from the target storage space, decompressing the startup data and transferring the decompressed startup data to the target container, so that the target container runs the startup data to complete startup of the target container.

According to a second aspect, an embodiment of the present disclosure provides a container startup apparatus, applied to a server. The apparatus includes:
an obtaining module, configured to obtain runtime environment configuration information of an application code file;
a creation module, configured to create, in the server, a target container for running the application code file based on the runtime environment configuration information; and obtaining, from a target storage space storing a metadata file and a compressed data file both of which correspond to the application code file, the metadata file, to transfer the metadata file to the target container, where the metadata file stores directory index information of each data block in the data file; and
a startup module, configured to read, in response to a startup data read request triggered by the target container based on the directory index information, corresponding startup data from the target storage space, decompress the startup data and transfer the decompressed startup data to the target container, so that the target container runs the startup data to complete startup of the target container.

According to a third aspect, an embodiment of the present disclosure provides a container startup method, including:
obtaining, in response to an update operation performed by a user on an application code file, a compressed file in a first file format corresponding to the updated application code file;
decompressing the compressed file in the first file format to obtain updated the application code file;
converting the updated application code file into a file in a second file format, where the file in the second file format includes a metadata file and a compressed data file both of which correspond to the updated application code file, and the metadata file stores directory index information of each data block in the data file; and
storing the file in the second file format into a target storage space, so that a server starts, in the server based on the file in the second file format, a target container running the updated application code file.

According to a fourth aspect, an embodiment of the present disclosure provides an electronic device, applied to a server, including: a memory, a processor, and a communication interface, where the memory has executable code stored therein, the executable code, when executed by the processor, causing the processor to perform the container startup method according to the first aspect or the third aspect.

According to a fifth aspect, an embodiment of the present disclosure provides a non-transitory machine-readable storage medium. The non-transitory machine-readable storage medium has executable code stored therein, the executable code, when executed by a processor of an electronic device, causing the processor to implement at least the container startup method according to the first aspect or the third aspect.

According to a sixth aspect, an embodiment of the present disclosure provides a function computing service system, including: a control plane component, a plurality of servers, and a plurality of storage spaces associated with the plurality of servers, where the plurality of storage spaces include storage spaces located in the plurality of servers and storage spaces not located in the plurality of servers; the plurality of storage spaces are configured to store a metadata file and a compressed data file both of which correspond to the application code file;
the control plane component is configured to receive a running request triggered by a client for an application code file, determine, based on locally stored container running status information corresponding to the application code file, whether a created container corresponding to the application code file is available, and trigger a container creation request corresponding to the application code file to a target server among the plurality of servers if it is determined that the created container corresponding to the application code file is not available; and
the target server is configured to perform at least the container startup method according to the first aspect.

The container startup method provided in the embodiments of the present disclosure may be performed in a function computing service system. The function computing service system includes a control plane component, a plurality of servers, and a plurality of storage spaces. When the control plane component receives a running request triggered by a client for an application code file, and it is determined, based on locally stored container running status information corresponding to the application code file, that a created container corresponding to the application code file is unavailable, a container creation request corresponding to the application code file is trigged to a certain target server.

The target server first obtains a runtime environment configuration information of the application code file, and creates, based on the runtime environment configuration information, a target container for running the application code file, for example, creating a virtual machine in the target server, and creating the target container in the virtual machine, to complete initial creation of the target container. Afterwards, a metadata file is obtained from a target storage space having the metadata file and a compressed data file both of which correspond to the application code file stored therein, and the metadata file is transferred to the target container. The target storage space is located in the target server or not located in the target server. In the embodiments of the present disclosure, the application code file of a user is stored in a target storage space in a specific file format. The file in such a file format includes a metadata file and a compressed data file both of which correspond to the application code file. The data file stores several data blocks obtained by dividing each sub-code file included in the application code file into data blocks. Each data block in the data file is compressed to obtain a compressed data file. The metadata file stores directory index information of each data block in the compressed data file.

During the initial creation of the target container, the directory index information of each data block in the metadata file is transmitted to the target container. In this way, the target container may identify which sub-code files are included in the application code file and a corresponding identifier of the data block included in each sub-code file in the data file. After the target container is created, the target container further needs to be started, so that the target container can run normally. The target container, based on the directory index information included in the locally visible metadata file described above, determines the directory index information corresponding to code required for startup (referred to as startup data), and triggers a read request for the determined directory index information, so as to eventually read the corresponding startup data from the target storage space. The startup data is decompressed and transferred to the target container. In this way, the target container runs the startup data to complete the startup process of the target container.

It may be learned that during the creation and startup of the target container, only the metadata file needs to be downloaded and parsed, and the data required for startup is read as needed based on the directory index information in the metadata file, without the need to download and decompress the complete data file, thereby accelerating the startup of the target container.

### BRIEF DESCRIPTION OF DRAWINGS

To describe technical solutions in embodiments of the present disclosure more clearly, the following briefly describes the accompanying drawings required for describing the embodiments. Apparently, the accompanying drawings in the following description show some embodiments of the present disclosure, and a person of ordinary skill in the art may derive other accompanying drawings from these accompanying drawings without creative efforts.

FIG. 1 is a schematic diagram of a function computing service system according to an embodiment of the present disclosure.

FIG. 2 is a schematic diagram of a file structure of an application code file with a converted format according to an embodiment of the present disclosure.

FIG. 3 is a flowchart of a container startup method according to an embodiment of the present disclosure.

FIG. 4 is a schematic diagram of a mapping relationship of file path information according to an embodiment of the present disclosure.

FIG. 5 is a schematic diagram of a transmission process of directory index information in a metadata file according to an embodiment of the present disclosure.

FIG. 6 is a flowchart of a container startup method according to an embodiment of the present disclosure.

FIG. 7 is a flowchart of a container startup method according to an embodiment of the present disclosure.

FIG. 8 is a flowchart of a container startup method according to an embodiment of the present disclosure.

FIG. 9 is a schematic structural diagram of a container startup apparatus according to an embodiment of the present disclosure.

FIG. 10 is a schematic structural diagram of an electronic device according to an embodiment of the present disclosure.

### DETAILED DESCRIPTION

To make the objectives, technical solutions, and advantages of the embodiments of the present disclosure clearer, the technical solutions in the embodiments of the present disclosure are to be clearly and completely described with reference to the accompanying drawings in the embodiments of the present disclosure. Obviously, the described embodiments are only some rather than all of the embodiments of the present disclosure. All other embodiments obtained by a person of ordinary skill in the art based on the embodiments in the present disclosure without creative efforts shall fall within the protection scope of the present disclosure. In addition, a sequence of steps in the following method embodiments is only an example and not a strict limitation.

It is to be noted that user information (including but not limited to user equipment information, user personal information, and the like) and data (including but not limited to data for analysis, stored data, displayed data, and the like) involved in the embodiments of the present disclosure are all information and data authorized by the user or fully authorized by all parties. The collection, use, and processing of relevant data need to conform to relevant laws, regulations, and standards of relevant countries and regions, and corresponding operation portals need to be provided for the user to choose to authorize or refuse.

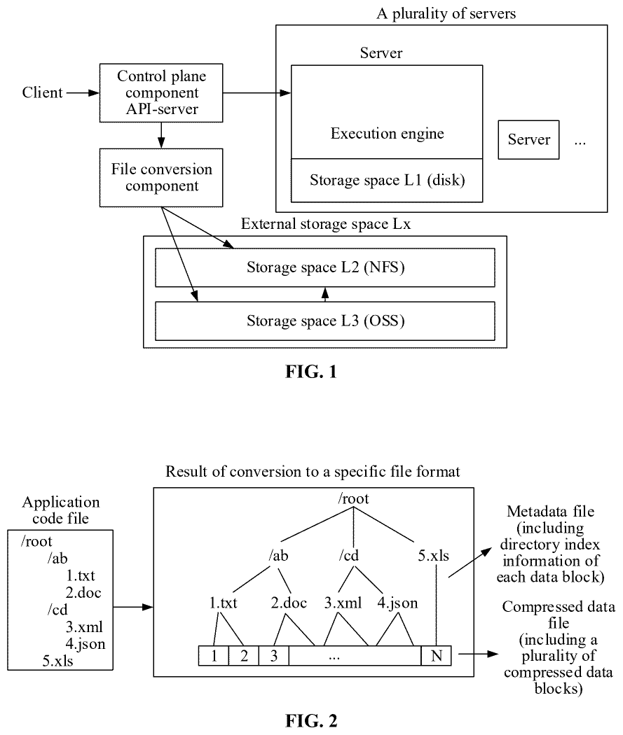

A container startup method provided in the embodiments of the present disclosure may be applicable to a function computing service system shown in FIG. 1. The system may include a control plane component, a plurality of servers, and a plurality of storage spaces.

The control plane component may be a functional component running in a virtual machine in the cloud, which mainly provides an interactive interface (an API interface) to the outside world to achieve interaction with a client and the foregoing server. Therefore, as shown in FIG. 1, the control plane component may also be referred to as an API server (an interface service component).

In general, the client may trigger, to the control plane component, requests such as an update request for the application code file and/or corresponding runtime environment configuration information thereof, and a running request for the application code file. The control plane component may trigger, in response to a request triggered by the client, requests such as a container creation request and an application code file running request to the server.

For example, in an embodiment, after the control plane component receives a running request triggered by a client for a certain application code file, and when it is determined, based on locally stored container running status information corresponding to the application code file, that a created container corresponding to the application code file is unavailable, a container creation request corresponding to the application code file is trigged to a target server.

In fact, the code included in the application code file provided by a user is capable of completing a certain function, such as a function of converting a resolution of a video or an image, or a function of detecting an abnormal value of running status data of a device. The user may trigger, based on an actual need, a running request for the application code file that has already been provided to the function computing service system. For example, when to-be-processed data (for example, the video, image, and running status data of a certain device collected in the above example) needs to be processed through the application code file, the foregoing running request is triggered, and the running request includes the to-be-processed data.

The function computing service system flexibly creates, for the user based on user requirements, one or more containers that run the application code file, and deletes the created container after a certain period of time upon completion of task execution, to achieve the purpose of elastic supply. In the foregoing control plane component, container running status information corresponding to the application code file may be stored. The container running status information reflects whether a container that has previously been created for the application code file still exists and is in an idle state. When it is determined, based on the container running status information, that the created container corresponding to the foregoing current application code file is unavailable, the control plane component selects a target server from a plurality of servers randomly or based on a load of each server, and triggers a container creation request for the application code file to the target server.

The created container corresponding to the foregoing application code file is unavailable. To be specific, the created container may be currently running the application code file to process other to-be-processed data, or the created container is deleted due to not running within a set time. It may be understood that if the created container is available, the to-be-processed data included in the foregoing running request may be sent to the created container, and the created container completes processing of the to-be-processed data by running relevant code in the application code file.

One or more target servers may be arranged. For example, the foregoing running request triggered by the client may include the required quantity of containers, or include a data volume of the to-be-processed data, and the control plane component accordingly determines a quantity of containers to be created. Then one target server may be selected to create the quantity of target containers in the target server. Alternatively, a plurality of target servers may be selected to create at least one target container in each target server, to run the foregoing application code file. In this specification, a container for running the application code file that is created by the server after receiving the foregoing container creation request is referred to as a target container.

The foregoing running request may further include runtime environment configuration information corresponding to the application code file, so that when it is determined that a target container corresponding to the application code file needs to be created, the runtime environment configuration information is carried in the foregoing container creation request and sent to the target server.

The target server performs a process of creation and startup of the target container corresponding to the application code file after receiving the foregoing container creation request, which is to be described in detail below. In fact, as shown in FIG. 1, each server includes an execution engine that provides a function computing service. The subsequent processes such as container creation and startup are completed by the execution engine.

As shown in FIG. 1, the plurality of storage spaces may include a storage space L1 located locally in each server, such as a disk, and may further include an external storage space Lx not located in any server. The storage space Lx may be shared by a plurality of servers.

In a practical application, the storage space Lx may be a storage space provided by an object storage service (OSS), or may be a network-side storage space provided by a network file system (NFS).

The storage space in the NFS may be mounted to the foregoing plurality of servers. In this way, from the perspective of the plurality of servers, a file path in the NFS at the remote end of a network seems to be local, and only needs to be read directly as needed without downloading.

In an optional embodiment, as shown in FIG. 1, the storage space Lx outside the server may include a storage space L2 provided by the NFS and a storage space L3 provided by the OSS. In this way, a three-level storage may be formed, that is, L1, L2, and L3. Since the storage space L1 is located locally in the server, and read and write performance of the storage space L2 is generally superior to that of the storage space L3. Therefore, speeds at which the server reads data from the three storage spaces may be ranked in descending order: the storage space L1>the storage space L2>the storage space L3.

Each of the foregoing storage spaces may be configured to store a file obtained after an application code file is converted into a specific file format. The file includes a metadata file and a compressed data file, both of which correspond to the application code file.

In fact, the application code file may include a plurality of sub-code files, and different sub-code files provide different functions. The application code file is actually a file with a directory structure. To facilitate understanding, a description is provided through an example with reference to FIG. 2. In FIG. 2, it is assumed that a root directory of an application code file is/root. The root directory is followed by two subdirectories /ab, /cd, and a sub-code file: 5.xls. In the subdirectory /ab, two sub-code files are included: 1.txt and 2.doc. In the subdirectory/cd, two sub-code files are included: 3.xml and 4.json.

During generation of the foregoing file in a specific file format, the sub-code files may be split into data blocks of a set size, and each data block is compressed. For example, if a size of a data block is 1 MB and a total data volume of the sub-code file is 100 MB, the sub-code file may be split into 100 data blocks. Assuming that the size of each data block is 0.3 MB after compression, the size of the data file including the compressed data blocks is 30 MB. Compared with 100 MB before compression, the data volume is reduced. In FIG. 2, it is assumed that the sub-code files are ultimately split into N data blocks as shown in the figure. A correspondence between the data block and the sub-code file is shown in FIG. 2. For example, the sub-code file 1.txt is split into a data block 1 and a data block 2.

The foregoing metadata file stores the directory index information of the data blocks corresponding to the foregoing sub-code files. The foregoing data block 1 is used as an example. Target index information corresponding to the data block is: /root/ab/1.txt/data block 1. It may be learned that the directory index information of each data block stored in the metadata file actually reflects directory hierarchy information of each sub-code file in the application code file, and corresponding identification information of a compressed data block in each sub-code file in the data file.

In a practical application, a specific file format of the foregoing metadata file and the data file may be formed, for example, a registry acceleration file system (RAFS) format.

In the embodiments of the present disclosure, the foregoing plurality of storage spaces may be configured to store the metadata file and a compressed data file obtained after the foregoing application code file is converted into a specific file format. The storage logic is to be described in detail below.

In an optional embodiment, before a user wants to use a personal application code file to process to-be-processed data, the application code file needs to be edited and generated and then uploaded to a function computing service system for storage.

In a practical application, the user may log in to an application code file creation interface of the function computing service system, complete editing of the personal application code file on the interface, and trigger a confirmation operation such as “save” or “submit” after completing the editing. During the editing, operations such as setting the runtime environment configuration information and selecting a compression format further need to be performed. The runtime environment configuration information includes, for example, a quantity of CPU cores to be used, memory capacity, network configuration, or a language environment. The compression format may be ZIP, RAR, or the like.

Based on the compression format selected by the user, the application code file is finally compressed accordingly, and then the compressed application code file is stored in a specific external storage space. The file compression format originally used by the user is referred to as a first file format, and the specific file format of the metadata file and the compressed data file obtained by the conversion is referred to as a second file format. As described above, the first file format may be the ZIP format, and the second file format may be an RAFS format. For the foregoing specific external storage space, the word “external” means not located inside any server. Referring to the example in FIG. 1, the external storage space is for example a storage space L3 provided by an OSS.

It is assumed that the original application code file in the ZIP format of the user is stored in the storage space L3, and a storage address C1 in the storage space L3 is provided to the control plane component. Subsequently, the control plane component may trigger format conversion processing for the application code file in the ZIP format. The control plane component may independently complete the conversion processing, or may complete the conversion processing through another functional component.

For example, as shown in FIG. 1, the function computing service system may further include a file conversion component, configured to convert a compressed file in a first file format corresponding to the application code file into a file in a second file format, that is, convert the foregoing application code file in the ZIP format into a file in the RAFS format, where the file in the RAFS format includes the foregoing metadata file and compressed data file. The file conversion component may be deployed in all or some of the foregoing plurality of servers, or may be deployed independently of these servers.

Specifically, the control plane component may send, to the file conversion component, a file conversion command carrying the foregoing storage address C1, a storage address C2, and a storage address C3. The storage address C1 is a storage address of the application code file in the ZIP format in the storage space L3, the storage address C3 is a destination storage address in the storage space L3 where the converted file in the RAFS format needs to be stored, and the storage address C2 is a destination storage address in the storage space L2 where the converted file in the RAFS format needs to be stored. Based on the file conversion command, the file conversion component reads and fully decompresses an application code file in the ZIP format from the storage address C1, converts the application code file into a file in the RAFS format, stores the file in the RAFS format into the foregoing storage addresses C2 and C3, and may feed back confirmation information to the control plane component after the conversion is successfully completed.

The foregoing example is based on an assumption that the external storage space includes the storage space L2 and the storage space L3. In fact, the external storage space may include only one of the two storage spaces.

Runtime environment configuration information corresponding to the application code file submitted by the user may also be stored in the control plane component. Specifically, the control plane component may store a correspondence between the following parameters: a user identifier, an application code file identifier, runtime environment configuration information, and corresponding storage addresses of the application code file in the foregoing two file formats in each external storage space. Based on this, when the client triggers a running request for the foregoing application code file, the control plane component may determine the corresponding runtime environment configuration information and the corresponding storage addresses of the application code file in the foregoing two file formats in each external storage space based on the user identifier and the application code file identifier included in the running request. When a container creation request is sent to the selected target server, the container creation request may carry the user identifier, the application code file identifier, the runtime environment configuration information, and the corresponding storage addresses of the application code file in the foregoing two file formats in each external storage space for use during the creation of the target container.

It is to be noted that in a practical application, in addition to creating the foregoing application code file, the user may further update the application code file and/or the runtime environment configuration information.

When the control plane component receives an update request for the application code file triggered by the client, if the update request only indicates that the runtime environment configuration information of the original application code file is updated, the control plane component sends a corresponding notification to the server in which a container corresponding to the application code file has been created, so that the server updates runtime environment configuration information of the created container, for example, adjusting a quantity of CPU cores or memory capacity as indicated in the update request. If the update request indicates that the user has updated the application code file, that is, the application code file is upgraded from the original old version to a new version, the control plane component may trigger the conversion and storage process of a new version of the application code file in the ZIP format into the RAFS format, and then when the user triggers a running request for the new application code file, a target container corresponding to the updated application code file is created.

In addition, it should be noted that the application code file created by the user includes at least one of the following: user-written code and a public layer function referenced by a user. In simple terms, the user-written code refers to code independently written by the user. During the writing, a public layer function provided by the function computing service system or a customized public layer function may be referenced. The public layer function may be regarded as a special code file. A dependent public library may be refined into a public layer function to reduce a volume of a code package during deployment and update.

In other words, if the user references the public layer function during the code writing, two application code files may ultimately be formed: one is a code file written by the user, and the other is a code file corresponding to the referenced public layer function. When a plurality of public layer functions are referenced, each public layer function corresponds to one application code file. Regardless of which of the application code files is used, the processing manner during the creation and startup of a container is similar.

The main functions of different components in the function computing service system are described above. The following is a detailed description of the process of creating and starting a container on the server with reference to the following embodiments.

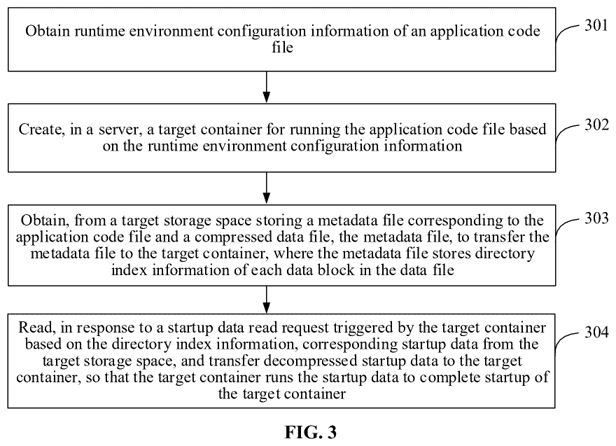

FIG. 3 is a flowchart of a container startup method according to an embodiment of the present disclosure. The method may be performed by any server in the system shown in FIG. 1. As shown in FIG. 3, the method includes the following steps.
301: Obtain runtime environment configuration information of an application code file.
302: Create, in the server, a target container for running the application code file based on the runtime environment configuration information.
303: Obtain, from a target storage space storing a metadata file and a compressed data file both of which correspond to the application code file, the metadata file, to transfer the metadata file to the target container, where the metadata file stores directory index information of each data block in the data file.
304: Read, in response to a startup data read request triggered by the target container based on the directory index information, corresponding startup data from the target storage space, and transfer decompressed startup data to the target container, so that the target container runs the startup data to complete startup of the target container.

As described above, a container creation request received by a certain server from a control plane component may include the runtime environment configuration information of the application code file, an application code file identifier, and corresponding storage addresses of the application code file in the foregoing two file formats in each external storage space. In addition, optionally, the container creation request may further include information such as a quantity of target containers to be created.

The server obtains the runtime environment configuration information of the application code file included in the container creation request, and may first complete an initial creation process of the target container based on the runtime environment configuration information: a virtual machine is created in the server, and a target container for running the application code file is created in the virtual machine. Certainly, if the foregoing container creation request includes the information about the quantity of target containers, a quantity of created virtual machines and the quantity of target containers are consistent with a quantity of target containers carried in the container creation request. Since the creation process of each target container is the same, the quantity is not differentiated herein.

In this embodiment of the present disclosure, for creation of a target container, a corresponding virtual machine first needs to be created, so as to create the target container in the virtual machine. Therefore, it may be considered that the virtual machine and the target container therein have the same life cycle, and the corresponding runtime environment configuration information may be considered as the same. As described above, the runtime environment configuration information may include a language type (for example, Java or nodejs), network configuration (for example, whether access to a public network is required), a required memory size, a quantity of CPU cores, and the like. Based on the runtime environment configuration information, corresponding memory and CPU resources are allocated in the server, and corresponding network and language environment configuration is performed, to complete the initial creation of the virtual machine and the target container.

In addition, during the creation of the virtual machine, in addition to the foregoing runtime environment configuration information, a configuration file used for creating the virtual machine may further include a configuration parameter: file path information corresponding to the metadata file and the compressed data file on the server. In this way, the created virtual machine can know information in which file path on the server to be read subsequently.

Based on this, if the foregoing file path information is referred to as second file path information, during creation of the virtual machine, the virtual machine may be created in the server based on the runtime environment configuration information and the second file path information.

However, the second file path information on the server is determined in the following manner: determining, based on first file path information of the metadata file and the compressed data file in the target storage space, second file path information to which the metadata file and the compressed data file are mapped on the server.

The target storage space may be a storage space L1 located in the server, or an external storage space Lx not located in the server. For example, if the external storage space includes only a storage space L2 or a storage space L3 as shown in FIG. 1, the target storage space may further be the storage space L2 or the storage space L3. If the external storage space includes only the storage space L2 and the storage space L3 as shown in FIG. 1, the target storage space may further be the storage space L2.

Specifically, it is assumed that storage spaces associated with the server include a first storage space located in the server and a second storage space not located in the server. For example, the first storage space is a local disk on the server, that is, the foregoing storage space L1, and the second storage space is the foregoing external storage space. Optionally, it is assumed that only one external storage space exists. To avoid ambiguity, it is assumed herein that the second storage space is the storage space Lx.

Then, if the metadata file and the compressed data file are stored in the storage space L1, the storage space L1 is determined as the target storage space. In this case, the first file path information of the metadata file and the compressed data file in the storage space L1 may be mapped to the server, to form the second file path information in a file system of the server.

However, if the metadata file and the compressed data file are not stored in the storage space L1, but the metadata file and the compressed data file are stored in the storage space Lx, the storage space Lx is determined as the target storage space. In this case, the first file path information of the metadata file and the compressed data file in the storage space Lx may be mapped to the server, to form the second file path information in the file system of the server.

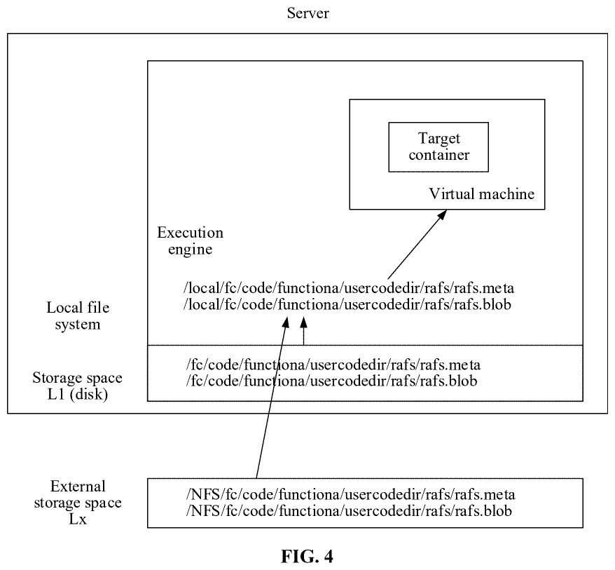

To facilitate understanding of the foregoing mapping relationship, a description is provided through an example with reference to FIG. 4.

In FIG. 4, it is assumed that a metadata file is a rafs.meta file in the figure, and compressed data file corresponds to files with a suffix of rafs.blob shown in the figure, respectively. In FIG. 4, it is assumed that the storage space Lx is a storage space provided by an NFS. In the storage space Lx, the first file path information of these two files is respectively:
/NFS/fc/code/functiona/usercodedir/rafs/rafs.meta
/NFS/fc/code/functiona/usercodedir/rafs/rafs.blob
where the NFS indicates a type of the storage space.

It is assumed that in the storage space L1, the first file path information of these two files is respectively:
/fc/code/functiona/usercodedir/rafs/rafs.meta
/fc/code/functiona/usercodedir/rafs/rafs.blob

In the local file system of the server, a default root directory may be set, such as/local. The second file path information mapped to the server based on the foregoing first file path information may be:
/local/fc/code/functiona/usercodedir/rafs/rafs.meta
/local/fc/code/functiona/usercodedir/rafs/rafs.blob

It may be learned that a result of the mapping is actually that a mapping relationship between the second file path information of the foregoing two files in the local file system of the server and the first file path information of the two files in the target storage space (the storage space L1 or the storage space Lx) is established. If these two files are stored in the storage space L1, during creation of the virtual machine and the target container this time, only the two files stored in the storage space L1 may be used.

Based on the above, after the virtual machine is created in the server based on the runtime environment configuration information and the second file path information, and the target container is created in the virtual machine, a startup process of the target container may be performed.

To start the target container, the metadata file first needs to be parsed into the virtual machine and the target container, so that the target container can learn which sub-code files are included in the application code file.

In general, the metadata file needs to be obtained from the target storage space storing the metadata file and the compressed data file both of which correspond to the application code file, so as to transfer the metadata file to the virtual machine and the target container.

Specifically, the metadata file may be read from the target storage space based on the mapping relationship between the second file path information and the first file path information in the target storage space. The metadata file is parsed to obtain the directory index information of each data block in the compressed data file stored in the metadata file, and then the directory index information is transferred to the virtual machine and displayed in the form of a directory. In the virtual machine, the directory index information is opened in a read-only mode to avoid modification.

In a practical application, optionally, a certain file sharing manner (such as a file system technology for virtualized shared files: a virtio-fs technology) may be used to transfer the metadata file to the virtual machine.

Afterward, the virtual machine may mount the directory index information to the target container in the form of a directory. The directory index information is also opened in the form of a directory in the target container and is set to the read-only mode.

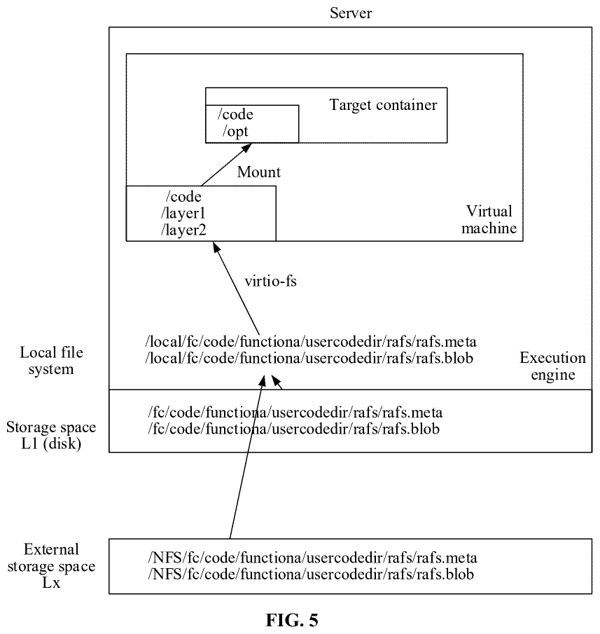

As described above, in a practical application, the application code file may be user-written code or may be one or more public layer functions. As shown in FIG. 5, if the application code file is the user-written code file, a code root directory/code may be set in the virtual machine, and it is assumed that the root directory is also set in the target container. Then the directory structure reflecting the foregoing directory index information in the metadata file is stored in the root directory. If the application code file is at least one public layer function, the metadata file corresponding to each public layer function in the virtual machine may each have a layer root directory, for example, layer root directories /layer1 and /layer2 corresponding to two public layer functions shown in the figure. However, when the directory index information is mounted to the target container, only one layer root directory/opt may be set in the target container. Then the directory index information in the metadata files corresponding to the two public layer functions in the two directories /layer1 and /layer2 needs to be merged into a directory structure to be mounted under the layer root directory/opt in the target container. The merging manner may be implemented through existing related technologies. Details are not described herein.

At this point, the directory index information included in the metadata file is mounted to the target container. Afterward, the target container may trigger a startup data read request based on the local directory index information. Specifically, the data required for starting the target container is referred to as startup data. The startup data read request triggered by the target container includes directory index information corresponding to the startup data. The virtual machine triggers a corresponding read instruction to the file system of the server based on the startup data read request. The server then reads, based on the directory index information corresponding to the startup data, the corresponding startup data as needed from the compressed data file in the target storage space that stores the metadata file and the compressed data file, and transfers the decompressed startup data to the target container, so that the target container runs the startup data to complete the startup of the target container.

It may be learned that in the embodiments of the present disclosure, a server that provides the function computing service only needs to read and parse the metadata file from the target storage space into the target container. Therefore, the target container may trigger the read request for the startup data as needed based on the directory index information included in the metadata file, so that only the data required for startup needs to be read as needed from the compressed data file, without the need to fully download and decompress all data files, thereby reducing the load of data downloading and decompression and increasing the container startup speed.

Even if the data volume of the application code file is relatively large, the data volume of the corresponding metadata file is still relatively small. Therefore, downloading and reading the metadata file does not take a long time and does not affect the startup speed of the target container.

The foregoing external storage space may be serverless. To be specific, storage resources provided by a cloud provider may be adopted, which may be paid as needed and dynamically expand capacity, so that operation and maintenance costs of the user can be relatively low and impose no limitation on the data size of the application code file.

After the target container is started, the application code file may be run to complete the task of processing the to-be-processed data inputted by the user. In simple terms, the control plane component may send a task processing request to the server. The task processing request includes information such as the to-be-processed data and an application code file identifier. The to-be-processed data is sent to the target container, and the target container may trigger read requests for different sub-code files in the application code file step by step as needed based on the directory index information in the local metadata file, so as to complete the processing of the to-be-processed data step by step through the sub-code files read each time. It is to be noted that the target container does not need to read all contents included in the application code file into the target container at once based on the foregoing directory index information, which may reduce consumption of resources such as memory and a CPU corresponding to the target container, because in fact, much data in the application code file may not be needed during the task processing.

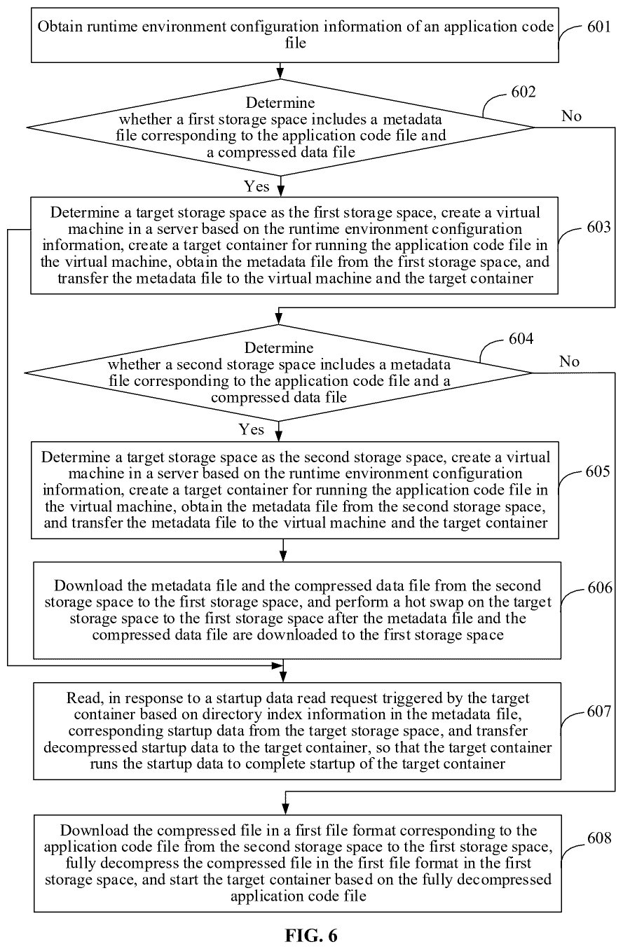

In the embodiment shown in FIG. 6, it is assumed that the server executing the startup of the target container is associated with at least two storage spaces. The at least two storage spaces include a first storage space located in the server and a second storage space not located in the server. Carrying on with the example in the above, the first storage space may be a local disk space of the server, that is, a storage space L1, and the second storage space may be an external storage space provided by for example an NFS or an OSS, which is represented as a storage space Lx. In other words, in the embodiment shown in FIG. 6, it is assumed that a two-level storage composed of the first storage space and the second storage space is formed.

In this case, the second storage space is configured to persistently store the metadata file and the compressed data file. In other words, after the application code file in a ZIP format provided by a user is converted into a file in an RAFS format, both the file in the RAFS format and the file in the ZIP format are persistently stored in the second storage space. The file in the RAFS format includes the foregoing metadata file and the compressed data file.

FIG. 6 is a flowchart of a container startup method according to an embodiment of the present disclosure. The method may be performed by any server in the system shown in FIG. 1. As shown in FIG. 6, the method includes the following steps.
601: Obtain runtime environment configuration information of an application code file.
602: Determine whether a first storage space includes a metadata file and a compressed data file both of which correspond to the application code file, if so, perform step 603, and otherwise, perform step 604.
603: Determine a target storage space as the first storage space, create a virtual machine in a server based on the runtime environment configuration information, create a target container for running the application code file in the virtual machine, obtain the metadata file from the first storage space, to transfer the metadata file to the virtual machine and the target container.
604: Determine whether a second storage space includes the metadata file and the compressed data file both of which correspond to the application code file, if so, perform step 605, and otherwise, perform step 608.
605: Determine a target storage space as the second storage space, create a virtual machine in a server based on the runtime environment configuration information, create a target container for running the application code file in the virtual machine, obtain the metadata file from the second storage space, to transfer the metadata file to the virtual machine and the target container.
606: Download the metadata file and the compressed data file from the second storage space to the first storage space, and perform a hot swap on the target storage space to the first storage space after the metadata file and the compressed data file are downloaded to the first storage space.
607: Read, in response to a startup data read request triggered by the target container based on directory index information in the metadata file, corresponding startup data from the target storage space, and transfer decompressed startup data to the target container, so that the target container runs the startup data to complete startup of the target container.
608: Download the compressed file in a first file format corresponding to the application code file from the second storage space to the first storage space, fully decompress the compressed file in the first file format in the first storage space, and start the target container based on the fully decompressed application code file.

In this embodiment, the second storage space is configured to persistently store files in a second file format, that is, the metadata file, the compressed data file, and the compressed file in the first file format, that is, the file obtained after the application code file is compressed based on the first file format. The compressed file in the first file format is used as a supplement when the file in the second file format is corrupted. In fact, the process of creating and starting the target container through the compressed file in the first file format belongs to the prior art, and details are not described in this embodiment.

The first storage space is located locally in the server. As described above, after the container corresponding to the application code file is created and started, the created container is to be deleted if no to-be-processed data needs to be processed within a set time, to reduce a waste of resources in the server. When the user subsequently needs to use the application code file again to perform a task, the corresponding container is to be recreated. Because in order to improve the utilization of the first storage space, regular garbage collection processing may be performed on the data stored in the first storage space. For example, when the storage capacity meets a first set data clearing condition, some data stored in the first storage space is cleared, for example, data that has not been accessed recently (within a set duration). Therefore, if the metadata file and the compressed data file both of which correspond to the foregoing application code file belong to this type of data, the files may be cleared from the first storage space.

It may be learned that in this embodiment, the server obtains the metadata file and the compressed data file from two data sources. One is the first storage space, and the other is the second storage space. Therefore, during the creation and startup of the virtual machine and the target container, it may be first determined which data source is currently used. The principle for selecting the data source is as follows. If the metadata file and the compressed data file are stored in the local first storage space of the server, the first storage space is determined as the data source, that is, the first storage space is determined as the target storage space. Otherwise, it is determined whether the metadata file and the compressed data file are stored in the second storage space. If the metadata file and the compressed data file are stored in the second storage space, the second storage space is determined as the data source, that is, the second storage space is determined as the target storage space.

In this case, optionally, the metadata file may be read from the second storage space and transferred to the virtual machine and the target container on the one hand, and the metadata file and the compressed data file may be downloaded from the second storage space to the first storage space on the other hand. After the downloading is completed, a hot swap is performed on the data source to the first storage space. Since the first storage space is local to the server, the first storage space may have better access performance than the second storage space. Afterwards, for example, during the reading of startup data, or during reading of a relevant sub-code file in order to process of the to-be-processed data, the first storage space may be used as the data source. The hot swap refers to a switching manner that does not affect container operation.

If the foregoing metadata file and the compressed data file are not stored in the second storage space either, for example, failing to store the metadata file and the compressed data file into the second storage space as a result of a failure of the conversion from the ZIP format to the RAFS format, or occurrence of some abnormal conditions during the conversion or during the storage of the converted file into the second storage space, the file in the ZIP format stored in the second storage space may be used to start the target container at this point. In this case, the compressed file in the ZIP format needs to be fully downloaded from the second storage space to the first storage space and fully decompressed, so as to start the target container and perform the subsequent task based on the decompressed application code file.

It may be learned that as long as the metadata file and compressed data file exist in the local storage space of the server, the external storage space does not need to be accessed, which may reduce a delay of starting the target container and provide reliable access stability.

In addition, in fact, after the user updates or creates the application code file, the conversion from the compressed file in the ZIP format to the file in the RAFS format is performed asynchronously, that is, after the compressed file in the ZIP format has been stored in the external storage space, the original application code file is read and decompressed to perform conversion to the RAFS format. Even if the conversion fails or another abnormal condition occurs, the original compressed file in the ZIP format may still be used to create and start the target container, so as to ensure that the user can use the updated application code file.

In fact, a relatively large quantity of target containers may need to be created in the server. For example, a client indicates the quantity of target containers that need to be created, or because a processing task for the to-be-processed data of the client is an offline task, creation and deletion of a container need to be performed frequently. Therefore, in order to further improve access performance, in an optional embodiment, the metadata file and startup data read from the first storage space may be stored in a memory for use when another container corresponding to the application code file is created in the server. In other words, the same content may be read from the disk (the first storage space) only once, and the read content is cached in the memory. Then, during subsequent creation and startup of another container corresponding to the application code file, the corresponding content may be read directly from the memory without the need to read the disk again.

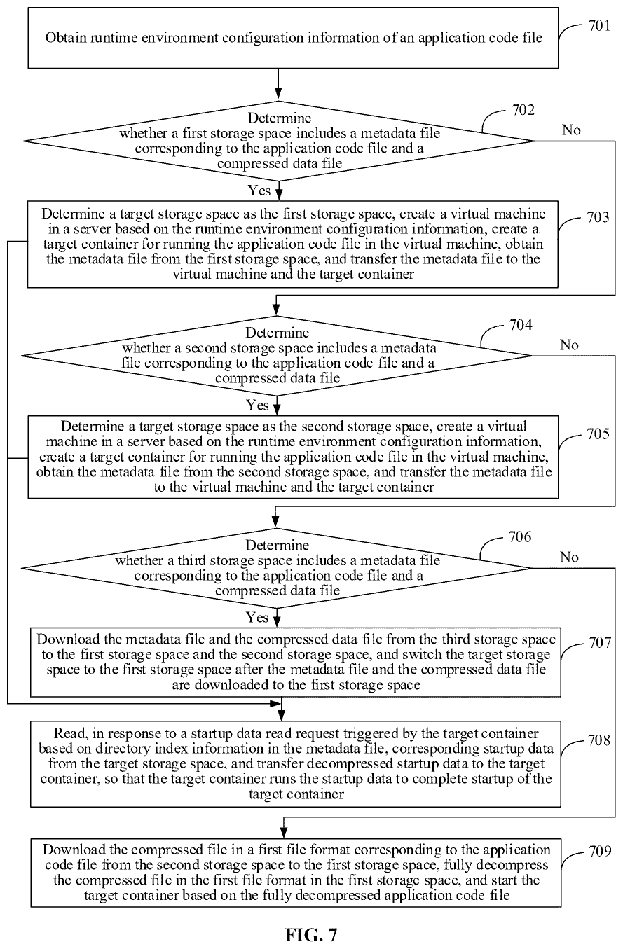

The foregoing embodiment describes a situation with a two-level cache. In the embodiment shown in FIG. 7, it is assumed that storage spaces associated with a server that performs startup of a target container include a first storage space located in the server, and a second storage space and a third storage space not located in the server. Carrying on with the examples in the above, the first storage space may be a local disk space of the server, that is, a storage space L1, the second storage space may be an external storage space provided by an NFS, which is represented as a storage space L2, and the third storage space may be a storage space provided by an OSS, which is represented as a storage space L3. In other words, in the embodiment shown in FIG. 7, it is assumed that a three-level cache composed of the first storage space L1, the second storage space L2, and the third storage space L3 is formed.

In this case, the third storage space L3 is configured to persistently store the metadata file and the compressed data file. In other words, after the application code file in a ZIP format provided by a user is converted into a file in an RAFS format, both the file in the RAFS format and the file in the ZIP format are persistently stored in the third storage space L3. The file in the RAFS format includes the foregoing metadata file and the compressed data file.

FIG. 7 is a flowchart of a container startup method according to an embodiment of the present disclosure. The method may be performed by any server in the system shown in FIG. 1. As shown in FIG. 7, the method includes the following steps.
701: Obtain runtime environment configuration information of an application code file.
702: Determine whether a first storage space includes a metadata file and a compressed data file both of which correspond to the application code file, if so, perform step 703, and otherwise, perform step 704.
703: Determine the first storage space as a target storage space, create a virtual machine in a server based on the runtime environment configuration information, create a target container for running the application code file in the virtual machine, obtain the metadata file from the first storage space, to transfer the metadata file to the virtual machine and the target container.
704: Determine whether a second storage space includes the metadata file and the compressed data file both of which correspond to the application code file, if so, perform step 705, and otherwise, perform step 706.
705: Determine the second storage space as a target storage space, create a virtual machine in a server based on the runtime environment configuration information, create a target container for running the application code file in the virtual machine, obtain the metadata file from the second storage space, to transfer the metadata file to the virtual machine and the target container.
706: Determine whether a third storage space includes the metadata file and the compressed data file both of which correspond to the application code file, if so, perform step 707, and otherwise, perform step 709.
707: Download the metadata file and the compressed data file from the third storage space to the first storage space and the second storage space, and switch the target storage space to the first storage space after the metadata file and the compressed data file are downloaded to the first storage space.
708: Read, in response to a startup data read request triggered by the target container based on directory index information in the metadata file, corresponding startup data from the target storage space, and transfer decompressed startup data to the target container, so that the target container runs the startup data to complete startup of the target container.
709: Download the compressed file in a first file format corresponding to the application code file from the second storage space to the first storage space, fully decompress the compressed file in the first file format in the first storage space, and start the target container based on the fully decompressed application code file.

In this embodiment, the third storage space is configured to permanently store a file obtained after the application code file is converted into a second file format: the metadata file and the compressed data file, and store the compressed file in the first file format corresponding to the application code file.

Garbage collection processing may be performed on both the second storage space and the first storage space.

For example, when the first storage space meets a first set data clearing condition, some data stored in the first storage space is cleared, and when the second storage space meets a second set data clearing condition, some data stored in the second storage space is cleared.

The first set data clearing condition may be, for example: when a storage capacity of the first storage space reaches a set threshold, data that has not been accessed recently (within a set duration) is cleared. Therefore, if the metadata file and the compressed data file both of which correspond to the foregoing application code file belong to this type of data, the files are to be cleared from the first storage space.

The second set clearing condition is similar. However, in fact, a set threshold corresponding to a storage capacity of the second storage space may be greater than the set threshold corresponding to the first storage space, and the foregoing set duration corresponding to the second storage space may be greater than the set duration corresponding to the first storage space. In simple terms, a data clearing frequency of the second storage space may be lower than that of the first storage space.

In this embodiment, the server obtains the metadata file and the compressed data file from two data sources. One is the first storage space, and the other is the second storage space. Therefore, during the creation and startup of the virtual machine and the target container, it may be first determined which data source is currently used. The principle for selecting the data source is as follows. If the metadata file and the compressed data file are stored in the local first storage space of the server, the first storage space is determined as the data source, that is, the first storage space is determined as the target storage space. Otherwise, it is determined whether the metadata file and the compressed data file are stored in the second storage space. If the metadata file and the compressed data file are stored in the second storage space, the second storage space is determined as the data source, that is, the second storage space is determined as the target storage space.

In addition, if the metadata file and the compressed data file are not stored in the first storage space, and the metadata file and the compressed data file are stored in the third storage space, the metadata file and the compressed data file may be downloaded from the third storage space to the first storage space, and the data source is switched to the first storage space. Similarly, if the metadata file and the compressed data file are not stored in the second storage space, the metadata file and the compressed data file may also be downloaded from the third storage space to the first storage space. However, in this case, if the first storage space already stores the metadata file and the compressed data file, the data source is not to be switched.

When none of the foregoing three storage spaces stores the metadata file and the compressed data file, the target container needs to be started through the compressed file in the first file format.

It may be learned that the data source may be hot-swapped between the first storage space and the second storage space. Specifically, before the metadata file and the compressed data file are fully downloaded to the first storage space, the second storage space may be used as the data source. After the metadata file and the compressed data file are downloaded to the first storage space, the data source is switched to the first storage space. During the period, no impact is caused on real-time access to data in the target container. Especially since the first storage space is located locally in the server, and the second storage space uses a network storage service such as an NFS, data downloading is not required, and a reading operation may be performed directly, which has good real-time performance and may ensure the startup speed of the target container. The third storage space is configured to persistently store the metadata file and the compressed data file. For example, even if the metadata file and the compressed data file are cleared from the first storage space and the second storage space due to garbage collection, a good startup acceleration effect may still be achieved through the metadata file and the compressed data file in the third storage space, because the directory index information in the metadata file still allows the target container to read and decompress data as needed without the need to fully download and decompress a data file. Furthermore, when the metadata file and the compressed data file are not present in the first storage space and the second storage space, the metadata file and the compressed data file may be downloaded from the third storage space to the first storage space and the second storage space, and the two-level cache is restored, so that the creation and startup of subsequent containers can be accelerated.

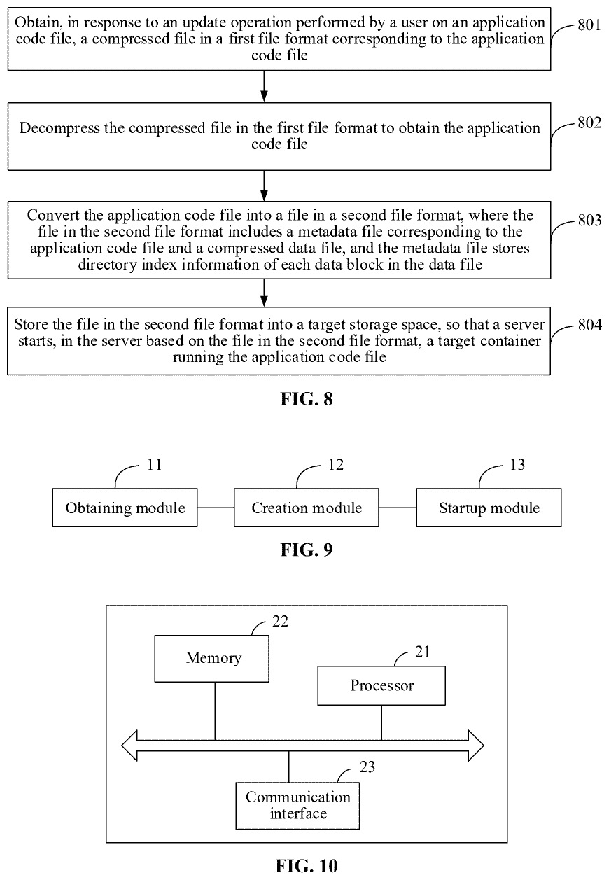

FIG. 8 is a flowchart of a container startup method according to an embodiment of the present disclosure. The method may be performed by the control plane component in the foregoing embodiments. As shown in FIG. 8, the method may include the following steps.
801: Obtain, in response to an update operation performed by a user on an application code file, a compressed file in a first file format corresponding to the application code file.
802: Decompress the compressed file in the first file format to obtain the application code file.
803: Convert the application code file into a file in a second file format, where the file in the second file format includes a metadata file and a compressed data file both of which correspond to the application code file, and the metadata file stores directory index information of each data block in the data file.
804: Store the file in the second file format into a target storage space, so that a server starts, in the server based on the file in the second file format, a target container running the application code file.

In this embodiment, the update operation performed by the user on the application code file may be editing and generating a new application code file, or upgrading and updating an existing application code file (that is, changing content therein). In a practical application, the update operation may further include updating runtime environment configuration information corresponding to the application code file.

As described above, the user may log in to an application code file creation interface of the function computing service system, complete editing of the personal application code file on the interface, and trigger a confirmation operation such as “save” or “submit” after completing the editing, so that the foregoing update operation may be triggered. During the editing, an operation such as selecting the foregoing first file format is performed, to store, into a target storage space, a file obtained after the application code file is compressed through the first file format. The target storage space is for example a certain storage space outside the server as exemplified above. A storage address corresponding to the compressed file in the first file format in the target storage space is provided to the control plane component. The control plane component may obtain and decompress the compressed file in the first file format to obtain the original application code file, and then perform conversion into the second file format. For the conversion process into the second file format, reference may be made to the relevant descriptions in the foregoing embodiments, and details are not described herein. Afterwards, the control plane component may store the file in the second file format into the target storage space for use in the subsequent process of creating the target container. For the process of creating and starting the target container, reference may be made to the relevant descriptions in the foregoing embodiments, and details are not described herein.

As described above, the user may further perform corresponding update settings of the runtime environment configuration information only for the existing application code file on the foregoing interface. In this case, the control plane component sends new runtime environment configuration information only to the server where a container running the application code file is located, so that the server updates the runtime environment configuration information corresponding to the container.

The implementation process of this embodiment may be understood by referring to the relevant descriptions in the foregoing embodiments.

A container startup apparatus according to one or more embodiments of the present disclosure is to be described in detail below. A person skilled in the art may understand that these apparatuses may be configured through the steps taught in this solution, and constructed using commercially available hardware components.

FIG. 9 is a schematic structural diagram of a container startup apparatus according to an embodiment of the present disclosure. As shown in FIG. 9, the apparatus includes an obtaining module 11, a creation module 12, and a startup module 13.

The obtaining module 11 is configured to obtain runtime environment configuration information of an application code file.

The creation module 12 is configured to create, in the server, a target container for running the application code file based on the runtime environment configuration information; and obtain, from a target storage space storing a metadata file and a compressed data file both of which correspond to the application code file, the metadata file, to transfer the metadata file to the target container, where the metadata file stores directory index information of each data block in the data file.

The startup module 13 is configured to read, in response to a startup data read request triggered by the target container based on the directory index information, corresponding startup data from the target storage space, and transfer decompressed startup data to the target container, so that the target container runs the startup data to complete startup of the target container.

Optionally, the creation module 12 is further configured to: determine, based on first file path information of the metadata file and the compressed data file in the target storage space, second file path information to which the metadata file and the compressed data file are mapped on the server; and create, in the server, a virtual machine based on the runtime environment configuration information and the second file path information, and create the target container in the virtual machine, where the metadata file is further transferred to the virtual machine.

Optionally, the server is associated with at least two storage spaces, and the at least two storage spaces include a first storage space located in the server and a second storage space not located in the server. Based on this, the creation module 12 is further configured to: determine that the target storage space is the first storage space if the metadata file and the compressed data file are stored in the first storage space; and determine that the target storage space is the second storage space if the metadata file and the compressed data file are not stored in the first storage space, and the metadata file and the compressed data file are stored in the second storage space.

Optionally, the startup module 13 is further configured to store the metadata file and the startup data read from the first storage space into a memory for use in creating another container corresponding to the application code file in the server.

Optionally, the second storage space is configured to persistently store the metadata file and the compressed data file. Based on this, the apparatus further includes a switching control module, configured to download the metadata file and the compressed data file from the second storage space to the first storage space if the metadata file and the compressed data file are not stored in the first storage space, and the metadata file and the compressed data file are stored in the second storage space; and switch the target storage space to the first storage space after the metadata file and the compressed data file are downloaded to the first storage space Optionally, the at least two storage spaces include a third storage space not located in the server, read and write performance of the third storage space is inferior to that of the second storage space, and the third storage space is configured to persistently store the metadata file and the compressed data file. Based on this, the switching control module is further configured to: download the metadata file and the compressed data file from the third storage space to the first storage space if the metadata file and the compressed data file are not stored in the first storage space; switch the target storage space to the first storage space after the metadata file and the compressed data file are downloaded to the first storage space; and download the metadata file and the compressed data file from the third storage space to the second storage space if the metadata file and the compressed data file are not stored in the second storage space.

Optionally, the apparatus further includes: a garbage collection module, configured to clear the metadata file and the compressed data file stored in the first storage space if a first set data clearing condition is satisfied; and clear the metadata file and the compressed data file stored in the second storage space if a second set data clearing condition is satisfied.

Optionally, the startup module 13 is further configured to download a compressed file in a first file format corresponding to the application code file from a storage space not located in the server to the first storage space located in the server if the metadata file and the compressed data file are not stored in the at least two storage spaces, where a second file format corresponding to the metadata file and the compressed data file is different from the first file format; fully decompress the compressed file in the first storage space; and start the target container based on the fully decompressed application code file.

Optionally, the application code file includes at least one of the following: user-written code and a public layer function referenced by a user. When the application code file includes a plurality of public layer functions, a respective metadata file corresponding to each of the plurality of public layer functions is transferred to the target container after directory index information in the respective metadata files is merged.

The apparatus shown in FIG. 9 may perform the steps performed by the server in the foregoing embodiments. For the detailed execution process and technical effects, reference is made to in the relevant descriptions in the foregoing embodiments, and details are not described herein again.

In a possible design, the structure of the container startup apparatus shown in FIG. 9 may be implemented as an electronic device. As shown in FIG. 10, the electronic device may include a processor 21, a memory 22, and a communication interface 23. The memory 22 has executable code stored therein, the executable code, when executed by the processor 21, causing the processor 21 to implement at least the container startup method provided in the foregoing embodiments.

In addition, an embodiment of the present disclosure provides a non-transitory machine-readable storage medium. The non-transitory machine-readable storage medium has executable code stored therein, the executable code, when executed by a processor of an electronic device, causing the processor to implement at least the container startup method provided in the foregoing embodiments.

The apparatus embodiments described above are merely examples. The units described as separate components may or may not be physically separate. Some or all of the modules may be selected according to actual needs to achieve the objectives of the solutions of the embodiments. A person of ordinary skill in the art may understand and implement the embodiments without creative efforts.

By means of the description of the above implementations, a person of ordinary skill in the art may clearly understand that the implementations may be implemented by a means of a necessary general hardware platform, or definitely, may also be implemented by a means of a combination of hardware and software. Based on this understanding, the above technical solution, or the part that contributes to the prior art, can be embodied in the form of a computer product. The present disclosure may be in the form of a computer program product implemented on one or more computer-usable storage media (including but not limited to a disk memory, a compact disc-read only memory (CD-ROM), and an optical memory) including computer-usable program code.

Finally, it should be noted that the above embodiments are merely intended to describe the technical solutions of the present disclosure, and are not intended to limit the present disclosure. Although the present disclosure is described in detail with reference to the foregoing embodiments, a person of ordinary skill in the art should understand that modifications may still be made to the technical solutions described in the above embodiments, or equivalent replacements may be made to some of the technical features. However, these modifications or replacements do not cause essence of corresponding technical solutions to depart from the spirit and scope of the technical solutions in the embodiments of the present disclosure.

1. A container startup method, applied to a server, the method comprising:
obtaining runtime environment configuration information of an application code file;
creating, in the server, a target container for running the application code file based on the runtime environment configuration information;
obtaining, from a target storage space storing a metadata file and a compressed data file both of which correspond to the application code file, the metadata file, to transfer the metadata file to the target container, wherein the metadata file stores directory index information of each data block in the data file; and
reading, in response to a startup data read request triggered by the target container based on the directory index information, corresponding startup data from the target storage space, decompressing the startup data and transferring the decompressed startup data to the target container, so that the target container runs the startup data to complete startup of the target container.

2. The method according to claim 1, further comprising:
determining, based on first file path information of the metadata file and the compressed data file in the target storage space, second file path information to which the metadata file and the compressed data file are mapped on the server, wherein
the creating, in the server, the target container for running the application code file based on the runtime environment configuration information comprises:
creating, in the server, a virtual machine based on the runtime environment configuration information and the second file path information, and creating the target container in the virtual machine, wherein the metadata file is further transferred to the virtual machine.

3. The method according to claim 1, wherein the server is associated with at least two storage spaces, and the at least two storage spaces comprise a first storage space located in the server and a second storage space not located in the server; and
the method further comprising:
determining that the target storage space is the first storage space if the metadata file and the compressed data file are stored in the first storage space; and
determining that the target storage space is the second storage space if the metadata file and the compressed data file are not stored in the first storage space, and the metadata file and the compressed data file are stored in the second storage space.

4. The method according to claim 3, further comprising:
storing the metadata file and the startup data read from the first storage space into a memory for use in creating another container corresponding to the application code file in the server.

5. The method according to claim 3, wherein the second storage space is configured to persistently store the metadata file and the compressed data file; and the method further comprising:
downloading the metadata file and the compressed data file from the second storage space to the first storage space if the metadata file and the compressed data file are not stored in the first storage space, and the metadata file and the compressed data file are stored in the second storage space; and
switching the target storage space to the first storage space after the metadata file and the compressed data file are downloaded to the first storage space.

6. The method according to claim 3, wherein the at least two storage spaces comprise a third storage space not located in the server, read and write performance of the third storage space is inferior to read and write performance of the second storage space, and the third storage space is configured to persistently store the metadata file and the compressed data file; and
the method further comprising:
downloading the metadata file and the compressed data file from the third storage space to the first storage space if the metadata file and the compressed data file are not stored in the first storage space;
switching the target storage space to the first storage space after the metadata file and the compressed data file are downloaded to the first storage space; and
downloading the metadata file and the compressed data file from the third storage space to the second storage space if the metadata file and the compressed data file are not stored in the second storage space.

7. The method according to claim 6, further comprising:
clearing the metadata file and the compressed data file stored in the first storage space if a first set data clearing condition is satisfied; and
clearing the metadata file and the compressed data file stored in the second storage space if a second set data clearing condition is satisfied.

8. The method according to claim 3, further comprising:
downloading a compressed file in a first file format corresponding to the application code file from a storage space not located in the server to the first storage space located in the server if the metadata file and the compressed data file are not stored in the at least two storage spaces, wherein a second file format corresponding to the metadata file and the compressed data file is different from the first file format;
fully decompressing the compressed file in the first storage space; and
starting the target container based on the fully decompressed application code file.

9. The method according to claim 1, wherein the application code file comprises at least one of: user-written code and a public layer function referenced by a user,
wherein when the application code file comprises a plurality of public layer functions, respective metadata files corresponding to each of the plurality of public layer functions are transferred to the target container after directory index information in the respective metadata files is merged.

10. A container startup method, comprising:
obtaining, in response to an update operation performed by a user on an application code file, a compressed file in a first file format corresponding to the updated application code file;
decompressing the compressed file in the first file format to obtain the updated application code file;
converting the updated application code file into a file in a second file format, wherein the file in the second file format comprises a metadata file and a compressed data file both of which correspond to the updated application code file, and the metadata file stores directory index information of each data block in the data file; and
storing the file in the second file format into a target storage space, so that a server starts, in the server based on the file in the second file format, a target container running the updated application code file.

11. An electronic device, applied to a server, comprising: a memory, a processor, and a communication interface, wherein the memory has executable code stored therein, the executable code, when executed by the processor, causing the processor to perform operations comprising:
obtaining runtime environment configuration information of an application code file;
creating, in the server, a target container for running the application code file based on the runtime environment configuration information;
obtaining, from a target storage space storing a metadata file and a compressed data file both of which correspond to the application code file, the metadata file, to transfer the metadata file to the target container, wherein the metadata file stores directory index information of each data block in the data file; and
reading, in response to a startup data read request triggered by the target container based on the directory index information, corresponding startup data from the target storage space, decompressing the startup data and transferring the decompressed startup data to the target container, so that the target container runs the startup data to complete startup of the target container.

12. A non-transitory machine-readable storage medium, having executable code stored therein, the executable code, when executed by a processor of an electronic device, causing the processor to perform the container startup method according to claim 1.

13. A function computing service system, comprising: a control plane component, a plurality of servers, and a plurality of storage spaces associated with the plurality of servers, wherein the plurality of storage spaces comprise storage spaces located in the plurality of servers and storage spaces not located in the plurality of servers;
wherein the control plane component is configured to receive a running request triggered by a client for an application code file, determine, based on locally stored container running status information corresponding to the application code file, whether a created container corresponding to the application code file is available, and trigger a container creation request corresponding to the application code file to a target server among the plurality of servers if it is determined that the created container corresponding to the application code file is not available;
wherein the target server is configured to perform the container startup method according to claim 1; and
wherein the plurality of storage spaces are configured to store a metadata file and a compressed data file both of which correspond to the application code file.

14. The system according to claim 13, further comprising:
a file conversion component, configured to convert a compressed file in a first file format corresponding to the application code file into a file in a second file format, wherein the file in the second file format comprises the metadata file and the compressed data file.

15. The electronic device according to claim 11, wherein the operations further comprise:
determining, based on first file path information of the metadata file and the compressed data file in the target storage space, second file path information to which the metadata file and the compressed data file are mapped on the server, wherein
the creating, in the server, the target container for running the application code file based on the runtime environment configuration information comprises:
creating, in the server, a virtual machine based on the runtime environment configuration information and the second file path information, and creating the target container in the virtual machine, wherein the metadata file is further transferred to the virtual machine.

16. The electronic device according to claim 11, wherein the server is associated with at least two storage spaces, and the at least two storage spaces comprise a first storage space located in the server and a second storage space not located in the server; and
the operations further comprise:
determining that the target storage space is the first storage space if the metadata file and the compressed data file are stored in the first storage space; and
determining that the target storage space is the second storage space if the metadata file and the compressed data file are not stored in the first storage space, and the metadata file and the compressed data file are stored in the second storage space.

17. The electronic device according to claim 16, wherein the operations further comprise:
storing the metadata file and the startup data read from the first storage space into a memory for use in creating another container corresponding to the application code file in the server.

18. The electronic device according to claim 16, wherein the second storage space is configured to persistently store the metadata file and the compressed data file; and the operations further comprise:
downloading the metadata file and the compressed data file from the second storage space to the first storage space if the metadata file and the compressed data file are not stored in the first storage space, and the metadata file and the compressed data file are stored in the second storage space; and
switching the target storage space to the first storage space after the metadata file and the compressed data file are downloaded to the first storage space.

19. The electronic device according to claim 16, wherein the at least two storage spaces comprise a third storage space not located in the server, read and write performance of the third storage space is inferior to read and write performance of the second storage space, and the third storage space is configured to persistently store the metadata file and the compressed data file; and
the operations further comprise:
downloading the metadata file and the compressed data file from the third storage space to the first storage space if the metadata file and the compressed data file are not stored in the first storage space;
switching the target storage space to the first storage space after the metadata file and the compressed data file are downloaded to the first storage space; and
downloading the metadata file and the compressed data file from the third storage space to the second storage space if the metadata file and the compressed data file are not stored in the second storage space.

20. The electronic device according to claim 19, wherein the operations further comprise:
clearing the metadata file and the compressed data file stored in the first storage space if a first set data clearing condition is satisfied; and
clearing the metadata file and the compressed data file stored in the second storage space if a second set data clearing condition is satisfied.
